(19) United States
(12) Patent Application Publication
(10) Pub. No.: US 2010/0182634 A1
(43) Pub. Date: Jul. 22, 2010

(54) IMAGE FORMING APPARATUS, AND CONTROL METHOD THEREOF

(75) Inventor: Jong-cheon HONG, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/574,922

(22) Filed: Oct. 7, 2009

(30) Foreign Application Priority Data
Jan. 20, 2009 (KR) 10-2009-0004590

(51) Int. Cl. G03G 15/00; H04N 1/00; G06F 3/12

(52) U.S. Cl. 358/1.15; 399/407; 358/402

(57) ABSTRACT

An image forming apparatus with a printing medium post-handling device having a structure to allow compatibility between apparatuses having different functions includes: an image forming unit which forms an image on a printing media; a post-handling device which includes a mailbox which includes one or more mail bins, sorts printing media discharged from the image forming unit in one or more sorting group, and loads the sorted printing media on the mail bins, and a post-handling unit that includes one or more post-handling bins and performs a post-handling function other than a mailbox function; a post-handling device selecting unit which selectively discharges the printing media to the post-handling device; and a controller which controls the post-handling device such that the one or more post-handling bins is used as an extra mail bin when the number of the sorting group of the post-handling device exceeds the number of mail bins.

### CROSS-REFERENCE TO RELATED APPLICATION

This application claims the benefit of Korean Patent Application No. 2009-4590, filed Jan. 20, 2009 in the Korean Intellectual Property Office, the disclosure of which is incorporated herein by reference.

### BACKGROUND OF THE INVENTION

1. Field of the Invention

Methods and devices consistent with aspects of the present invention relate to an image forming apparatus, and a control method of the image forming apparatus, and more particularly, to an image forming apparatus with a printing medium post-handling device having a structure to allow compatibility between apparatuses having different functions, and a control method of the image forming apparatus.

2. Description of the Related Art

In general, a printing medium post-handling device is equipped in an image forming apparatus such as a printer, a copy machine, a facsimile, a multifunction copier or the like. Examples of the printing medium post-handling device may include a mailbox, a finisher, a booklet, etc. A mailbox includes a plurality of mail bins on which printing media are loaded. The mailbox performs a function to sort and load printing media for each individual or for each group using the plurality of mail bins. A finisher performs a stapler function of stapling discharged printing media, or an offset function of stacking output prints at predetermined intervals so that the output prints can be sorted in a task unit or in a document set unit.

In an image forming apparatus employing the conventional mailbox and finisher, the mailbox and the finisher are configured to perform only their own functions. Accordingly, when the mailbox function is to be used, there is a problem in that the mailbox function can not be extended beyond the number of mail bins included in the mailbox.

### SUMMARY OF THE INVENTION

Accordingly, it is an aspect of the present invention to provide an image forming apparatus with a structure to allow a mailbox function be extended beyond the number of mail bins by utilizing a post-handling device applied along with a mailbox, and a control method the image forming apparatus.

The foregoing and/or other aspects of the present invention can be achieved by providing an image forming apparatus including: an image forming unit which forms an image on a printing media; a post-handling device which includes a mailbox which includes one or more mail bins, sorts printing media discharged from the image forming unit in one or more sorting group, and loads the sorted printing media on the mail bins, and a post-handling unit that includes one or more post-handling bins and performs a post-handling function other than a mailbox function; a post-handling device selecting unit which selectively discharges the printing media to the post-handling device; and a controller which controls the post-handling device such that the one or more post-handling bins play a role of mail bin of the mailbox if the number of the sorting group of the post-handling device exceeds the number of mail bins.

According to an aspect of the invention, the controller may use logical bin array information on the mail bins and post-handling bins, the information being provided from the post-handling device, when the printing media are sorted in the sorting group and discharged.

According to an aspect of the invention, the image forming apparatus may further include a mode setting unit which sets a post-handling function, including the mailbox function, depending on a selection from a user.

According to an aspect of the invention, the post-handling unit may include a finisher which has one or more finisher bins and staples or offsets the printing media.

The foregoing and/or other aspects of the present invention can be achieved by providing an image forming apparatus forms an image on a printing medium based on a print data from a host which comprises a printer driver installed to convert data into a printable format comprising: an image forming unit which forms an image on the printing medium; a post-handling device which includes a mailbox which includes one or more mail bins, sorts printing media discharged from the image forming unit in one or more sorting group, and loads the sorted printing media on the mail bins, and a post-handling unit that includes one or more post-handling bins and performs a post-handling function other than a mailbox function; a post-handling device selecting unit which selectively discharges the printing media to the post-handling device; and a controller which controls the image forming unit, the post-handling device and the post-handling device selecting unit and transmits information on mount of the post-handling device and information on operation mode of the mail bins and post-handling bins to the host, and, wherein, if the number of the sorting group of the post-handling device exceeds the number of mail bins, the printer driver controls the image forming apparatus such that one or more of the post-handling bins of the post-handling unit play a role of mail bin of the mailbox.

According to an aspect of the invention, the printer driver may use logical bin array information on the mail bins and post-handling bins, the information being provided from the post-handling device, when the printing media are sorted in one or more sorting group.

According to an aspect of the invention, the image forming system may further include a user interface unit which sets a post-handling function, including the mailbox function.

According to an aspect of the invention, the post-handling unit may include a finisher which has one or more finisher bins and staples or offsets the printing media.

The foregoing and/or other aspects of the present invention can be achieved by providing a control method of an image forming apparatus, including: upon registering a post-handling device including a mailbox which is mounted on a body of the image forming apparatus, adding logical bin information corresponding to mail bins of the mailbox and post-handling bins other than the mail bins to logical bin array information; endowing a logical bin corresponding to the mail bins and post-handling bins with a name; if the number of sorting group of the post-handling device exceeds the number of mail bins, executing a select algorithm for the logical bin endowed with the name so that one or more of the post-handling bins play a role of mail bin of the mailbox; and outputting printing media to the mail bins or post-handling bins corresponding to the logical bin selected through the select algorithm.

According to an aspect of the invention, the control method may further include: determining whether an error occurs when the printing media are output; and, if it is determined that the error occurs, searching and displaying a bin having the error occurred in a logical bin.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, in which:

FIG. 1 is a schematic sectional view showing an image forming apparatus according to an exemplary embodiment of the invention.

FIG. 2 is a schematic block diagram showing an image forming apparatus according to an exemplary embodiment of the invention.

FIG. 3 is a schematic block diagram showing an image forming system according to an exemplary embodiment of the invention.

FIG. 4 is a flow chart showing a control method of an image forming apparatus according to an exemplary embodiment of the invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures. In the following embodiments, for the purpose of clarity, like components are denoted by the same reference numerals throughout the drawings, and explanation thereof will be representatively given in a first embodiment but will be omitted in other embodiments.

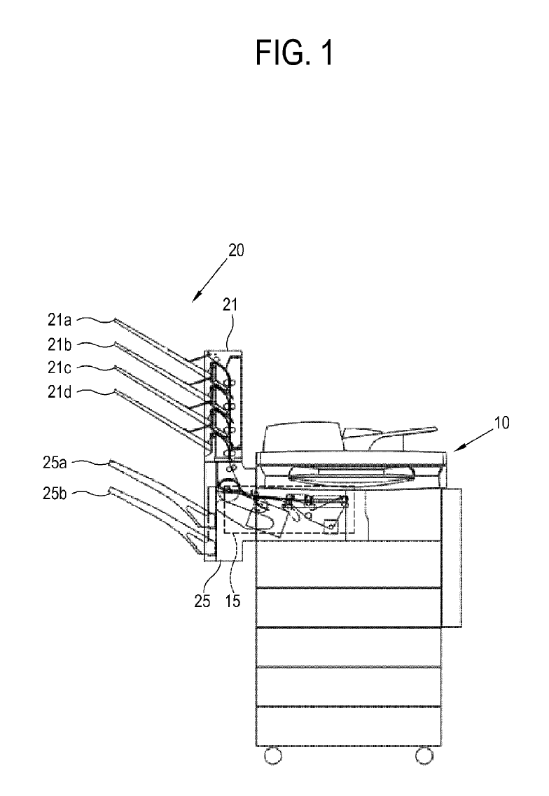

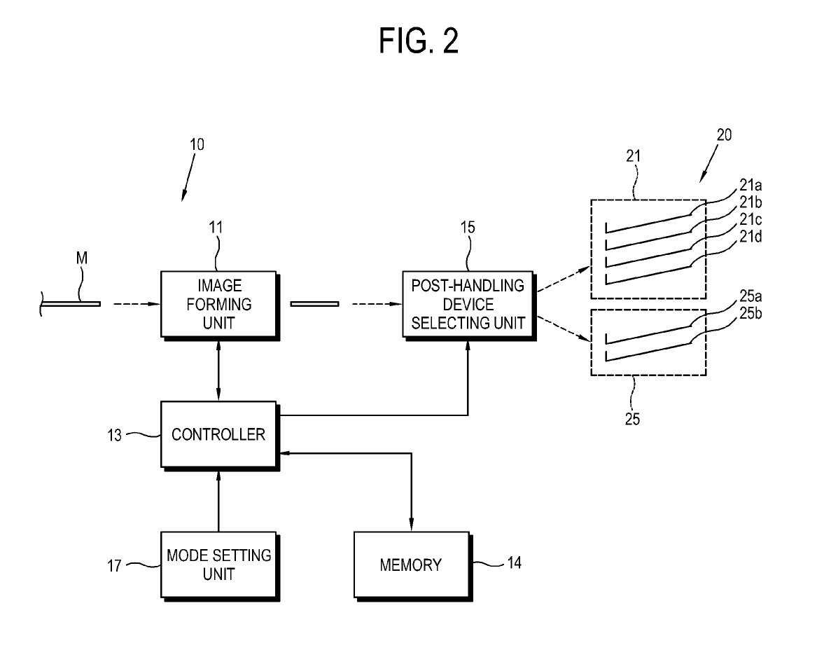

FIG. 1 is a schematic sectional view showing an image forming apparatus according to an exemplary embodiment of the invention, and FIG. 2 is a schematic block diagram showing an image forming apparatus according to an exemplary embodiment of the invention. Referring to FIGS. 1 and 2, an image forming apparatus 10 includes an image forming unit 11, a post-handling device 20, a post-handling device selecting unit 15, and a controller 13 that controls the image forming apparatus 10 as a whole. The image forming unit 11 forms an image on a printing medium M. The post-handling device 20 handles the printing medium M having the image formed thereon. The post-handling device selecting unit 15 selects the post-handling device 20 to which the printing medium M is discharged. The image forming apparatus according to this embodiment may perform at least one of functions of print, copy, scan, facsimile, or combinations thereof.

The image forming unit 11 forms an image on a supplied printing medium M through an image forming process. Examples of the image forming process include, but are not limited to, an electrophotographic type process, a thermal transfer type process, an inkjet type process or the like. The configuration of the image forming unit 11 is known in the art and, therefore, a detailed explanation thereof will be omitted.

The post-handling device 20 includes a mailbox 21. The mailbox 21 includes one or more mail bins 21a, 21b, 21c and 21d, and a post-handling unit 25 that performs a post-handling function other than a mailbox function, such as collating multiple copies of the same document. The mailbox 21 sorts printing media M discharged from the image forming unit 11 in one or more sorting groups and separates and loads the sorted printing media on the mail bins 21a, 21b, 21c and 21d. That is, the mailbox 21 has a plurality of mail bins, mail bins 21a to 21d, for example, as shown in FIGS. 1 and 2, and performs a function of sorting and loading printing media up to four for each individual or each group. The number of mail bins can be more or less than the shown four.

The post-handling unit 25 is a unit for performing a post-handling function other than the mailbox function. For example, the post-handling function can be a document finishing function performed by a finisher, for example, a finisher which performs booklet making, folds documents for use as folders, stitches sides and/or corners to create bound copies, etc. FIGS. 1 and 2 show a finisher as an example of the post-handling unit 25. The shown finisher has one or more finisher bins 25a and 25b and staples or offsets printing media M. That is, the finisher performs a stapler function of stapling discharged printing media or an offset function of stacking output prints at predetermined intervals so that the output prints can be sorted in a task unit or in a document set unit in the corresponding bins 25a, 25b. FIGS. 1 and 2 illustrate first and second finisher bins 25a and 25b by way of example, but it is understood that other numbers can be used.

The controller 13 controls the post-handling device selecting unit 15 such that a printing medium M having an image formed thereon by the image forming unit 11 is discharged to the post-handling device 20 (that is, one of the mailbox bins 21a, 21b, 21c, 21d or one of the finisher bins 25a, 25b). In addition, if the number of sorting group of the post-handling device 20 exceeds the number of mail bins 21a to 21d, the controller 13 controls the post-handling device 20 such that at least one finisher bin 25a and 25b of the post-handling unit 25 plays a role of a mail bin of the mailbox 21. That is, if the demand for the mailbox 21 exceeds the number of physical mail bins 21a to 21d, the controller 13 determines whether or not an available finisher bin 25a and 25b of the post-handling device except the mailbox 21 is present. If the controller 13 determines that extra finisher bins 25a, 25b are present, the controller 13 controls the extra finisher bins 25a, 25b to play a role of mail bin. While not limited thereto, the controller 13 can be one or more processors and/or a computer implementing instructions encoded on one or more computer readable media.

For example, as shown in FIGS. 1 and 2, when the first to fourth mail bins 21a to 21d are provided, if a user wishes to sort prints into five groups, the mailbox 21 is short one mail bin. In this case, the controller 13 determines whether or not a mail bin is lacking and whether or not any of the first and second finisher bins 25a and 25b is empty. If it is determined that the first finisher bin 25a is empty, the controller 13 controls the first finisher bin 25a to play a role of the fifth mail bin.

To this end, upon mounting the post-handling device 20 including the mailbox 21 on a body of the image forming apparatus 10, the controller 13 may use logical bin array information of mail bins 21a to 21d and finisher bins 25a and 25b to detect the number and position of all bins, regardless of whether the bins are specifically mailbox bins, and grant an identifier to each bin. In this case, the identifier may have a serial number in accordance with a mount state of bin or a specific name designated by a user for each bin. In addition, the controller 13 may group the plurality of mail bins 21a, 21b, 21c, 21d so that several physical mail bins can perform a single mail bin function. While not required in all aspects, the logical bin array information can be stored in the memory 14, which can be an optical, magnetic or other storage media.

As described above, since the controller 13 controls at least some finisher bins to perform the function of a mail bin, the function of mailbox 21 can be normally performed without mounting additional mailboxes even if the mailbox 21 is short one or more mail bin.

The finisher bins 25a, 25b designated to perform the function of mailbox can be restored to perform their original function depending on setup by a user, with lapse of time, or when information to cause an inherent function of the finisher bins to be performed is input.

While not required in all aspects, the shown example of the image forming apparatus further includes a mode setting unit 17. The mode setting unit 17 sets a post-handling function including the function of mailbox 21 depending on a selection from a user.

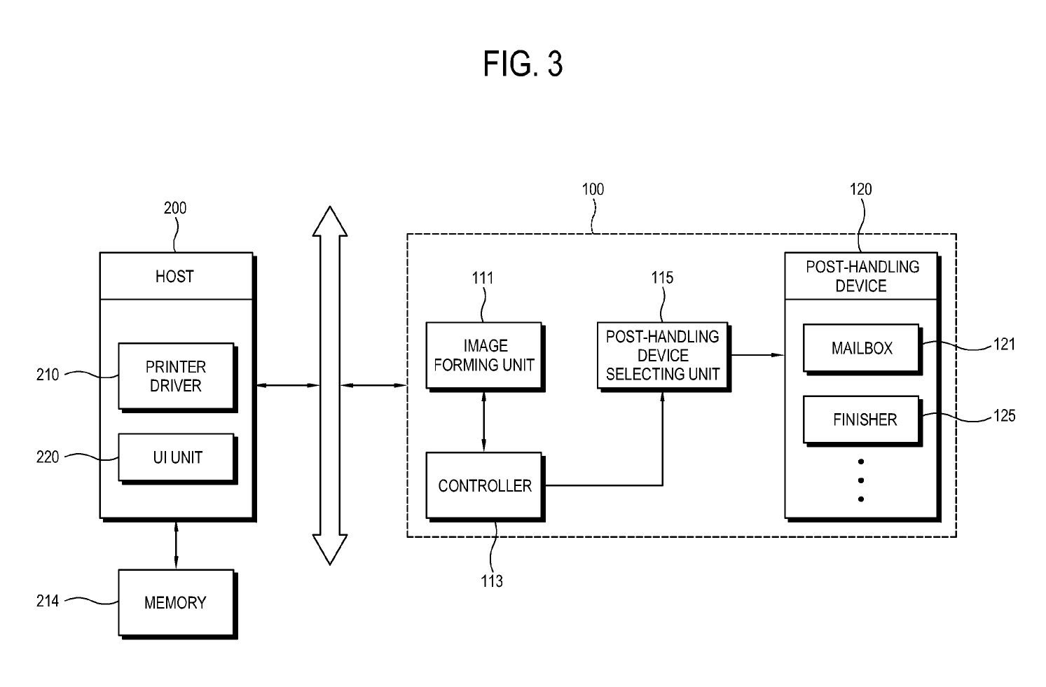

FIG. 3 is a block diagram showing an image forming system according to an exemplary embodiment of the invention. Referring to the FIG. 3, the imaging forming system includes a host 200 including a printer driver 210 for converting data into a printable format, and an image forming apparatus 100 that forms an image on a printing medium based on print data received from the host 200. The host 200 can be a computer, a camera, a personal digital assistant, or like computational device.

The image forming apparatus 100 includes an image forming unit 111, a controller 113, a post-handling device selecting unit 115 and a post-handling device 120. The post-handling device 120 includes a mailbox 121 that includes one or more mail bins, sorts printing media discharged from the image forming unit 111 in one or more sorting groups, and loads the sorted printing media on the mail bins. The post handling device 120 further includes a post-handling unit that includes one or more post-handling bins and performs a post-handling function other than a mailbox function. Here, as the post-handling unit, a finisher 125 may be included which has one or more finisher bins and staples or offsets printing media, as shown in FIG. 3.

The controller 113 controls the image forming unit 111 to form an image on a printing medium and controls the post-handling device selecting unit 115 to select the post-handling device 120 from which a printing media having an image formed thereon is discharged. In addition, the controller 113 transmits information on the mounting of the post-handling device 120 and information on operation modes of the mail bins and post-handling bins to the host 200.

The printer driver 210 installed in the host 200 converts print data into a printing language and provides the converted print data to the controller 130. Examples of the printing language include, but are not limited to, a printer command language (PCL), a post script (PS) or the like.

In addition, if the number of sorting group of the post-handling device 120 exceeds the number of mail bins, the printer driver 210 controls the image forming apparatus 100 such that at least one of the post-handling bins of the post-handling unit (for example, a finisher bin of the finisher 125) plays a role of mail bin of the mailbox 121.

The printer driver 210 may use logical bin array information on mail bins and post-handling bins, which is provided from the post-handling device 120, when printing media are sorted in one or more sorting groups. That is, when the post-handling device 120 including the mailbox 121 is mounted on a body of the image forming apparatus 100, the printer driver 210 may use the logical bin array information on mail bins and post-handling bins to detect the number and position of entire bins and may grant an identifier to each bin. In this case, the identifier may use a serial number in accordance with a mount state of bin or a specific name designated by a user for each bin. In addition, the printer driver 210 may group the plurality of mail bins so that several physical mail bins can perform a single mail bin function. While not required in all aspects, the logical bin array information can be stored in the memory 214, which can be an optical, magnetic or other storage media.

In addition, while not required in all aspects, the shown host 200 further includes a user interface (UI) unit 220 for setting a post-handling function, including the function of mailbox 121 and the finisher 125.

The image forming system as configured in FIG. 3 has an advantage of an extension of the function of mailbox without mounting additional mailboxes by using post-handling bins of the post-handling device mounted along with the mailbox when printing media are sorted and loaded beyond the number of mail bins of the mailbox, depending on a selection from a user.

In addition, the use of the printer driver 210 installed within the host 200 in performing the extension function of mailbox facilitates an access by a user and an update of a program to implement the above function.

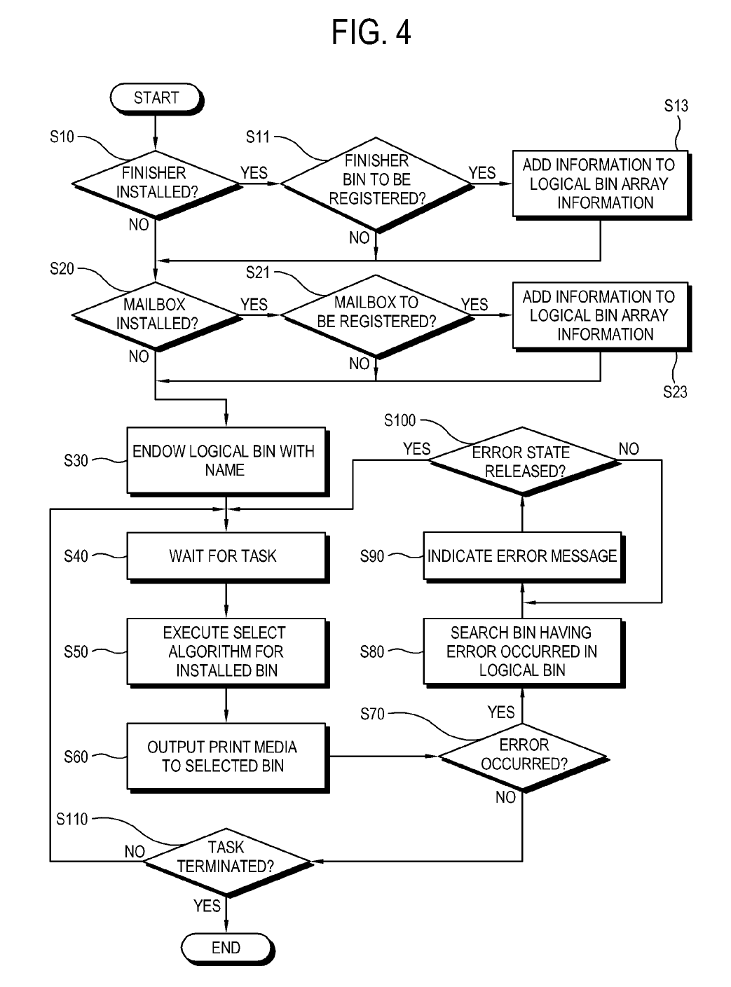

Hereinafter, a control method of the image forming apparatus according to an exemplary embodiment of the invention will be described with reference to FIGS. 2 and 4. When the post-handling device 20 including the mailbox 21, which is mounded on the body of the image forming apparatus 10, is registered, logical bin information corresponding to the mail bins 21a to 21d of the mailbox 21 and the post-handling bins 25a and 25b other than the mail bins is added to the logical bin array information. That is, it is determined whether or not the finisher 25 is installed on the body of the image forming apparatus 10 (S10). If it is determined that the finisher 25 is installed, it is determined whether or not a finisher bin is to be registered (S11). If it is determined that no finisher 25 is installed or if there is no need to register any finisher bin, the process proceeds to operation S20. If it is determined that a finisher bin is to be registered, this information is added to the logical bin array information (S13) and then operation S20 is performed.

In operation S20, it is determined whether or not the mailbox 21 is installed on the body of the image forming apparatus 10. If it is determined that the mailbox 21 is installed, it is determined whether or not a mail bin is to be registered (S21). If it is determined that no mail bin is installed or if there is no need to register any mail bin, the process proceeds to operation S30. On the other hand, if it is determined that a mail bin is to be registered, this information is added to the logical bin array information (S23) and then operation S30 is performed. While not required in all aspects, the logical bin array information can be stored in the memory 14, which can be an optical, magnetic or other storage media.

In operation S30, a logical bin corresponding to the mail bins and post-handling bins included in the logical bin array information is given a name. The name of the logical bin may be a serial number or a unique name given by a user. Thereafter, a task such as print, scan, copy or the like to be performed by the image forming apparatus waits to start (S40).

Upon starting a task, a select algorithm is executed for an installed bin (S50). That is, if the number of sorting group of the post-handling device exceeds the number of mail bins, the select algorithm is executed for the logical bin having the name so that at least one post-handling bin plays a role of mail bin of the mailbox. If the number of sorting group of the post-handling device does not exceed the number of mail bins, the select algorithm is executed for the mail bins without using the post-handling bins. While not required in all aspects, the logical bin array information having information on the logical bins is retrieved by the controller 13 from the memory 14, the controller 13 detects which of the logical bins is not being used for either the mailbox function or the post-handing function, and the controller 13 selects an unused one of the logical bins as the additional mail bin using the logical bin information.

Moreover, while not required in all aspects, when one of the mail bins 21a to 21d is broken or otherwise unavailable, the controller 13 updates the logical bin information to reduce the number of mail bins 21a to 21d, and executes the select algorithm (S50) to use one of the usable post-handling bins 25a and 25b as the additional mail bin when the number of available mail bins 21a to 21d is insufficient to handle a sorting operation.

Then, by outputting printing media to the mail bins and post-handling bins corresponding to the logical bin selected through the select algorithm (S60), the function of mailbox 21 can be extended beyond the number of mail bins of the physical mailbox 21.

In performing operation S50, if a user selects a function other than the mailbox function (i.e., a unique function of the post-handling bin), a restoration function as the unique function may be included. In other words, it is determined whether or not a printing medium is loaded on a post-handling bin diverted to a mailbox, and if the printing medium is not loaded, a designation for a mail bin is released. On the other hand, if the printing medium is loaded, a message informing a user of a use condition of the post-handling bin is indicated.

While not required in all aspects, the shown method further includes operation S70 to determine whether or not an error occurs when a printing medium is output. If no error occurs, it is determined whether or not the task is to be terminated (S110). If the task is not to be terminated, the process returns to operation S40.

If it is determined that an error occurs (S70), a bin having the error is searched (S80), and an error message indicating information on the bin having the error may be displayed, such as through the mode setting unit 17 of FIG. 2 or the UI unit 220 of FIG. 3 (S90). Subsequently, it is determined whether or not an error state is released (S100). If it is determined that the error state is released, operation S40 is performed. If the error state remains, operation S90 is performed.

The above-described control method of the image forming apparatus according to an embodiment of the invention has an advantage of extension of mailbox function beyond the number of mail bins by using post-handling bins of the post-handling unit other than the mailbox without additional mailboxes. In addition, if an error occurs, by providing a user with information on a bin in which the error occurred, there is an advantage of quickly removing the error.

The image forming system of aspects of the present invention as configured above has an advantage of extension of the function of mailbox without mounting additional mailboxes by using post-handling bins of the post-handling device mounted along with the mailbox when printing media are sorted and loaded beyond the number of mail bins of the mailbox, depending on a selection from a user.

In addition to the advantage of the above-described image forming apparatus, the image forming system of aspects of the present invention can facilitate an access by a user by using the printer driver installed within the host in performing the extension function of mailbox. Moreover, this system has another advantage of facilitating an update of a program to implement the above function.

The above-described control method of the image forming apparatus according to an embodiment of the invention has an advantage of extension of mailbox function beyond the number of mail bins by using post-handling bins of the post-handling unit other than the mailbox without additional mailboxes. In addition, if an error occurs, by providing a user with information on a bin in which the error occurred, there is another advantage of quickly removing the error. While not required in all aspects, all or part of the method of the present invention can be implemented using software and/or firmware stored on one or more computer readable media and implemented using one or more processors and/or computers.

Although a few embodiments of the present invention have been shown and described, it would be appreciated by those skilled in the art that changes may be made in this embodiment without departing from the principles and spirit of the invention, the scope of which is defined in the appended claims and their equivalents.

What is claimed is:

1. An image forming apparatus comprising:
an image forming unit which forms an image on a printing media;
a post-handling device which includes
a mailbox which includes one or more mail bins, sorts printing media discharged from the image forming unit in one or more sorting groups, and loads the sorted printing media having the image into the mail bins to perform a mailbox function, and
a post-handling unit that includes one or more post-handling bins and performs a post-handling function on the printing media other than the mailbox function;
a post-handling device selecting unit which selectively discharges the printing media to the post-handling device; and
a controller which controls the post-handling device such that the one or more post-handling bins is used as a mail bin of the mailbox if a number of a requested sorting group exceeds a number of mail bins of mailbox of the post-handling device.

2. The image forming apparatus according to claim 1, wherein the controller uses logical bin array information on the mail bins and post-handling bins, the information being provided from the post-handling device, when the printing media are sorted in the sorting group and discharged.

3. The image forming apparatus according to claim 1, further comprising a mode setting unit which sets a post-handling function selectable between the mailbox function and the post-handling function, depending on a selection from a user.

4. The image forming apparatus according to claim 1, wherein the post-handling unit includes a finisher which staples or offsets the printing media into the post-handling bins.

5. An image forming apparatus forms an image on a printing medium based on a print data received from a host which comprises a printer driver installed to convert data into print data having a printable format comprising:
an image forming unit which forms an image on the printing medium;
a post-handling device which includes
a mailbox which includes one or more mail bins, sorts printing media discharged from the image forming unit in one or more sorting groups, and loads the sorted printing media having the image into the mail bins to perform a mailbox function, and
a post-handling unit that includes one or more post-handling bins and performs a post-handling function on the printing media other than the mailbox function;
a post-handling device selecting unit which selectively discharges the printing media to the post-handling device; and
a controller which controls the image forming unit, the post-handling device and the post-handling device selecting unit and transmits information on whether the post-handling device is mounted to the image forming apparatus and information on an operation mode of the mail bins and post-handling bins to the host, and
wherein, if a requested number of the sorting groups exceeds a number of mail bins of the mailbox of the post-handling device, the printer driver controls the image forming apparatus to use one or more of the post-handling bins of the post-handling unit as a mail bin of the mailbox according to the transmitted information on the operation mode of the mail bins and post-handling bins.

6. The image forming apparatus according to claim 5, wherein the printer driver uses logical bin array information on the mail bins and post-handling bins, the information being provided from the post-handling device, when the printing media are sorted in the sorting group.

7. The image forming apparatus according to claim 5 further comprising a user interface unit which sets a post-handling function selectable between the mailbox function and the post-handling function.

8. The image forming apparatus according to claim 5, wherein the post-handling unit includes a finisher which staples or offsets the printing media into the one or more post-handling bins.

9. A control method of an image forming apparatus, comprising:
upon registering a post-handling device including a mailbox which is mounted on a body of the image forming apparatus, adding logical bin information corresponding to mail bins of the mailbox and post-handling bins other than the mail bins to logical bin array information;
assigning a name to a logical bin for each of the mail bins and post-handling bins;
if a number of a requested sorting group exceeds a number of mail bins of the mail box of post-handing device, executing a select algorithm on the logical bins having the assigned names so that one or more of the post-handling bins is used as a mail bin of the mailbox; and
outputting printing media to the mail bins and the one or more post-handling bins corresponding to the logical bin selected through the select algorithm.

10. The control method of an image forming apparatus according to claim 9, further comprising:
determining whether an error occurs when the printing media are output; and
if it is determined that the error occurs, searching and displaying a corresponding assigned name of the logical bin having the error.

11. An image forming apparatus comprising:
an image forming unit which forms an image on a printing media;
a post-handling device which includes a mailbox which includes one or more mail bins, sorts printing media discharged from the image forming unit into the mail bins, and loads the sorted printing media having the image into the corresponding one or more mail bins to perform a mailbox function, and a post-handling unit that includes one or more post-handling bins and performs a post-handling function on the printing media other than the mailbox function; and
a post-handling device control unit which comprises
a memory which stores logical bin information comprising identifiers for each of the mail bins and each of the post-handling bins; and
a controller which recalls the stored logical bin information, and controls the post-handling device such that the one or more post-handling bins is used as an extra mail bin of the mailbox according to the stored logical bin information.

12. The image forming apparatus of claim 11, wherein
the controller recalls the stored logical bin information and controls the post-handling device to use the one or more post-handling bins as the extra mail bin when a number of mail bins needed for a requested sorting group exceeds a number of the mail bins in the post-handling device.

13. The image forming apparatus of claim 12, when the number of mail bins needed for the requested sorting group does not exceed the number of the mail bins in the post-handling device, the controller controls the post-handling device to only use the mail bins for the sorted printing media.

14. The image forming apparatus of claim 11, wherein the controller is within the image forming apparatus and further controls an operation of the image forming unit.

15. The image forming apparatus of claim 11, wherein:
the controller is within a host communicating with the image forming apparatus to provide a printing document used by the image forming unit to form the image on the printing media and which is sorted using the mailbox function, and
the controller further receives information from the image forming apparatus on an availability of each of the post-handling bins, and assigns the one or more post-handling bins to be used as the extra mail bin according to the received availability information.

16. The image forming apparatus of claim 11, wherein
the controller detects when a change in a number of mail bins and post-handling bins occurs in the post-handling device, and updates the stored logical bin information in the memory according to the detected changed number of mail bins and post-handling bins.

17. A control method of an image forming apparatus comprising an image forming unit which forms an image on a printing media, a post-handling device which includes a mailbox which includes one or more mail bins, sorts printing media discharged from the image forming unit into the mail bins, and loads the sorted printing media having the image into the corresponding one or more mail bins to perform a mailbox function, and a post-handling unit that includes one or more post-handling bins and performs a post-handling function on the printing media other than the mailbox function, the method comprising:
receiving print information requesting printing media be sorted into a number of sorting groups;
when the number of sorting groups exceeds a number of the mail bins in the mailbox, assigning at least one post-handling bin using stored logical bin information comprising identifiers for each of the mail bins and each of the post-handling bins; and
sorting the printing media using the mail bins and the assigned post-handling bin.

18. The control method of claim 17, wherein the assigning the at least one post-handling bin is performed by a controller within the image forming apparatus and which further controls an operation of the image forming unit.

19. The control method of claim 17, wherein the assigning the at least one post-handling bin is performed by a controller which is within a host communicating with the image forming apparatus to provide a printing document used by the image forming unit to form the image on the printing media and which is sorted using the mailbox function, the method further comprising transmitting from the host to the image forming apparatus the assigned at least one post-handling bin and receiving from the image forming apparatus information on an availability of each of the post-handling bins.
